(19) United States
(12) Patent Application Publication
(10) Pub. No.: US 2008/0107836 A1
(43) Pub. Date: May 8, 2008

(54) Method and Apparatus for Spacing Artwork from a Transparent Covering in a Picture Frame

(76) Inventor: Brian Barnett, Dunwoody Atlanta, GA (US)

Correspondence Address: GLENN PATENT GROUP, 3475 EDISON WAY, SUITE L, MENLO PARK, CA, 94025, US

(21) Appl. No.: 11/557,637

(22) Filed: Nov. 8, 2006

(51) Int. Cl. A47G 1/12; C03C 27/06

(52) U.S. Cl. 428/14; 156/109

(57) ABSTRACT

The invention provides a method and apparatus for spacing artwork from a transparent covering in a picture frame that addresses production problems encountered by large chain stores and high volume framers that use current spacer designs. The spacer herein disclosed is generally rectangular in shape with a protrusion extending from one side.

### BACKGROUND OF THE INVENTION

1. Technical Field

The invention relates to picture frames. More particularly, the invention relates to a method and apparatus for spacing artwork from a transparent covering in a picture frame.

2. Description of the Prior Art

In mounting expensive artwork in frames it is the normal procedure to mount a glass or plastic sheet or panel in front of the artwork to protect it against damaging effects. It is also important to keep front sheet adequately spaced from the artwork so that there is no engagement between the two which would cause structural damage to the artwork, such as ink transfer, mold growth (foxing), and buckling. Preferably dust and dirt particles should be kept out of the space between the sheet and the artwork so that the artwork is effectively preserved for long periods of time and does not become discolored or otherwise affected by foreign particles in the space.

Until the early '80s, framers used many materials to space artwork away from the protective glass or plastic sheet. These materials were referred to as spacers and were generally hand-made of wood, cardboard or, in some cases, cut from sheets of acrylic plastic. In most cases, the spacers were rectangular in shape and held in place using glue. Beginning in the early '80s, three different types of extruded commercial plastic spacers became available from three different suppliers. The suppliers of the spacers shown in FIG. 1 and FIG. 2 are still in business. The spacer shown in FIG. 3 is no longer manufactured.

For many years, these commercial spacers served the needs of individual retail frame shops. The framer was often the owner and very skilled at framing and the consumer paid a premium for premium framing and service, unless they opted to do their own framing.

Recently, much of the lower end framing is being done by large chain stores which have hundreds of outlets. These stores buy in large volume and offer framing at substantially lower cost than the traditional frame shops that dominated framing in the past. They continue to take a significant amount of business from small individual frame shops. To offer the lowest possible cost for framing, these chains typically use relatively unskilled framers. How quickly artwork can be framed is an important consideration.

FIG. 1 shows a clear plastic spacer 14 which has adhesive material 11 on one surface so that the spacer can be pressed against the protective glass or plastic sheet 13 and held in place or, in the alternative, numbers of spacers can be stacked on top of one another and held in place to provide more space between the protective glass or plastic sheet 13 and the artwork 15 to be displayed. A backing panel 16 completes the assembly.

In another embodiment, not shown, the spacer has adhesive material on two orthogonal surfaces so that the separator can be secured to protective glass or plastic sheet and can also be secured to the side wall of the frame.

In another embodiment the spacer is hollow 17. Clear plastic separators assume the color of the item to be displayed, such as a picture, and therefore, eliminate the necessity to properly color a separator device. Because the spacer is plastic, it does not absorb water and therefore does not become mildewed or acidic or have any negative reactions with moisture which may be condensed between the protective glass or plastic sheet and the artwork.

This type of spacer is difficult to use because, once the protective covering is removed from the adhesive and a spacer is pressed into place, It is difficult to remove and re-position, Spacers of this type must be installed rather than simply dropped into position, as will be described later. It is difficult to position the spacer on the edge of the glass properly without first placing the glass in the molding 12 and then pressing the spacer against the side of the molding while keeping it suspended adequately above the glass to prevent the adhesive from pre-maturely sticking while sliding the spacer into position against the glass, Often it happens that the spacers are installed so tightly against the molding that it is nearly impossible to remove the glass for cleaning and restoration. It is also difficult to clean the inside of the glass thoroughly with the spacer adhered to the glass. Spacers can not be pre-cut and ready to install without first removing the protective covering on the tape. This precludes being able to easily have bins of parts that are cut to standard industry sizes

FIG. 2 shows a spacer 24, generally S-shaped in cross-section, which can be made of any length and cut to size for use with any particular picture frame. The S-shape permits the spacer to have two open-sided recesses instead of a single recess, The spacer is made of resilient material so that a pair of opposed end walls forming parts of the spacer can yield outwardly of an intermediate wall of the spacer to increase the widths of the open-sided recesses formed by the end and intermediate walls of the spacer. In the case of an S-shaped spacer, one recess is wider than the other recess to accommodate sheets of different thicknesses. The S-shaped spacer is therefore reversible in a frame so that, for a relatively thin sheet, one of the recesses is used. Whereas, for a relatively thick sheet, the other recess is used. In either case, the part of the spacer forming the recess not in use defines the spacer portion of the spacer.

This spacer is very difficult and time-consuming to install because it is necessary, according to the manufacturer, to first break the sharp edges of the glass with a whetstone to allow the spacer to be stretched over the edge of the glass. Once the spacers are in place around the edge of the glass, the glass is carefully dropped into the frame. A common complaint in the industry is that this spacer design does not grip the edge of the protective glass or plastic sheet very well and one or more sections of spacer are prone to falling off while handling the glass to install the remaining sections of space. Once installed, it is easy to knock a spacer out of position so that the spacer/protective glass or plastic sheet glass assembly does not fit within the molding opening. When glass is used as the protective covering, as is most often the case with chain stores, the extra handling required to use this spacer increases the chance framers can cut themselves.

FIG. 3 shows a hollow, rectangular spacer 33 with a wall extension 31. This spacer was discontinued about three years ago. For many years, this spacer was distributed by a major international distributor of picture frame molding and supplies. This spacer was supplied in two sizes 33a, 33b (see FIG. 4) and used as shown. The purpose of the wall extension is undetermined, but because the length of said wall extension is much longer than the thickness of any protective glass or plastic sheet, its only function can be to provide additional mechanical support to hold the spacer in place should the adhesive 32 fail. The design was discontinued about three years ago. For the twelve years prior, framing supply distributors had been selling spacers of the type described in FIGS. 3 and 4.

This spacer design has the same installation limitations the spacer shown in FIG. 1 described above has in that it requires an adhesive and requires careful placement, Further, it has the added disadvantage that the glazing cannot be removed without removing the spacers which have been attached with adhesive to the molding.

### SUMMARY OF THE INVENTION

The invention solves the above described production problems encountered by large chain stores and high volume framers that use current spacer designs. To that end, the spacer of this invention generally rectangular in shape with a protrusion extending from one side. While the invention described herein specifically addresses making it easier and less time consuming for relatively unskilled framers to use the described invention, it follows that more skilled framers in individual frame shops also benefit from the improvements. While large chain stores are an important market, high volume framers who may frame 10,000 pictures at a time for mass markets, such as hotel and restaurant chains, can benefit because of the ease with which spacers can be fully staged for assembly, as will be discussed below.

### BRIEF DESCRIPTION OF THE DRAWINGS

FIG. 1 is a sectional view of a picture frame assembly incorporating a prior art spacer between the artwork and the glazing material;

FIG. 2 is a sectional view of a picture frame assembly incorporating a second type of prior art spacer between the artwork and the glazing material;

FIG. 3 is a sectional view of a picture frame assembly incorporating a third type of prior art spacer between the artwork and the glazing material;

FIG. 4 is a sectioned perspective view of a picture frame assembly incorporating the third type of prior art spacer between the artwork and the glazing material;

FIG. 5 is a sectional view of a picture frame assembly incorporating a spacer between the artwork and the glazing material according to the invention;

FIG. 6 shows a picture frame assembly (FIG. 6a) incorporating a spacer between the artwork and the glazing material, as further shown through section A-A (FIG. 6b), according to the invention;

FIG. 7 is a sectional view of a picture frame assembly incorporating a spacer between the artwork and the glazing material, shown along section line A-A of FIG. 6, in which the steps for assembling the picture frame and the spacer are shown according to the invention.

FIG. 8 is a detailed sectional view a picture frame assembly incorporating a spacer between the artwork and the glazing material, further demonstrating the criticality of the preferred dimensions of the preferred spacer (FIGS. 8a and 8b) according to the invention; and

FIG. 9 is a detailed profile view showing key dimensions of an exemplary spacer according to the invention.

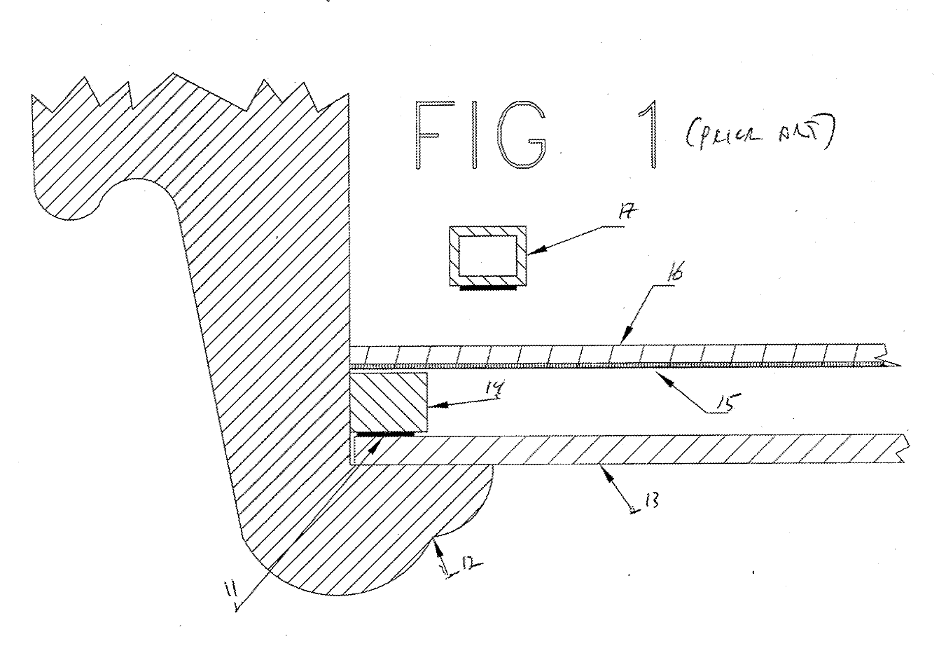

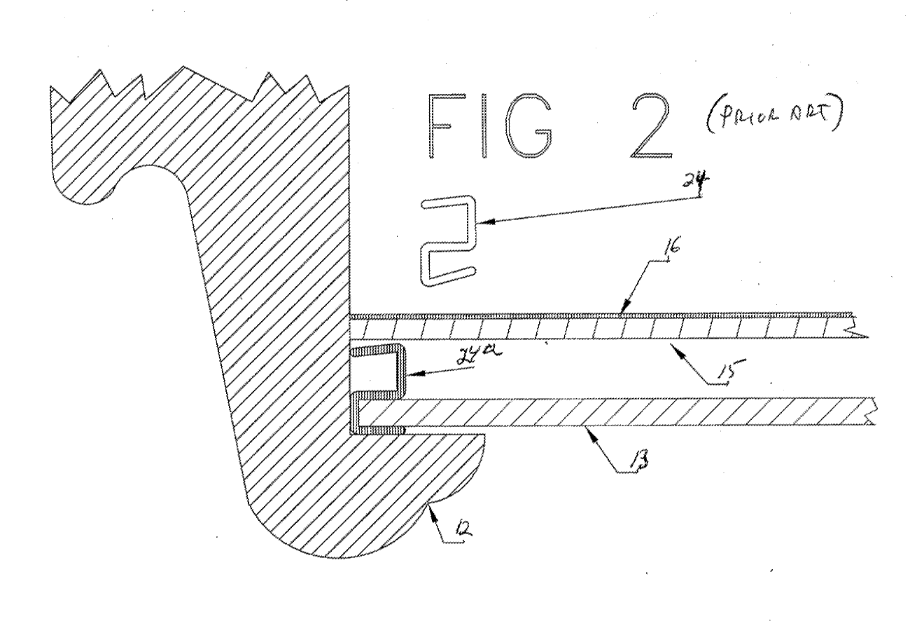

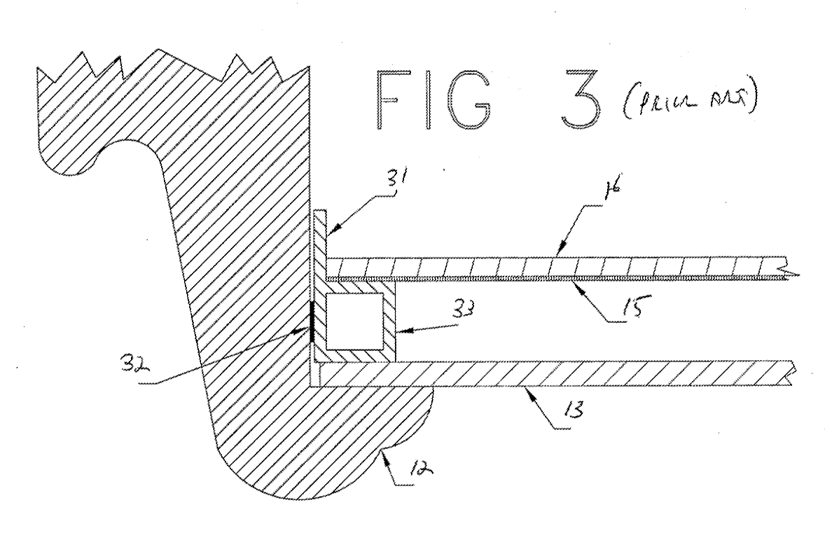

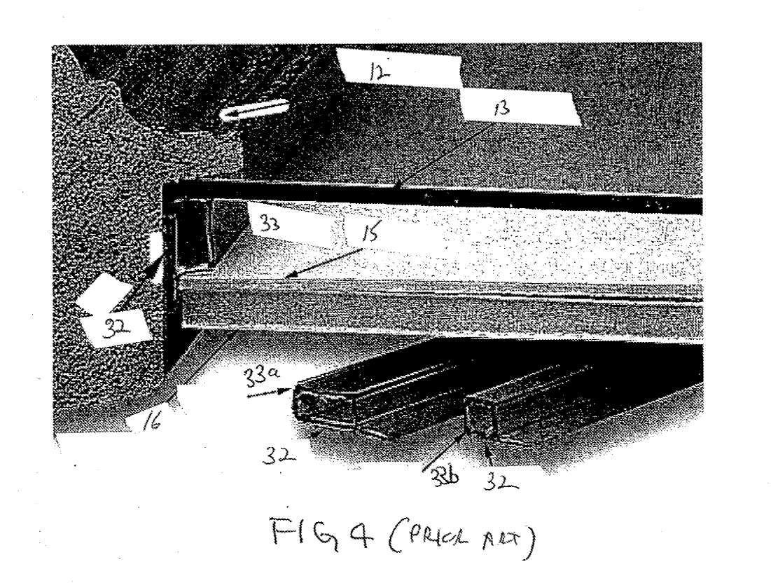

### DETAILED DESCRIPTION OF THE INVENTION

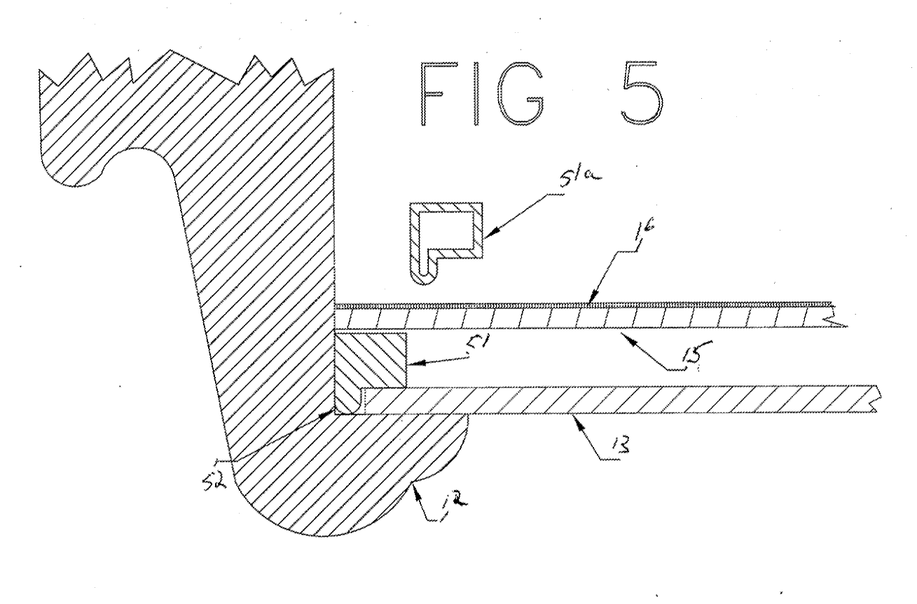

The invention solves the above described production problems encountered by large chain stores and high volume framers that use current spacer designs, To that end, the spacer of this invention is shown in FIG. 5. The improved spacer 51, 51a is generally rectangular in shape with a protrusion 52 extending from one side.

To use this spacer, the size of protective glass or plastic sheet is traditionally cut to the nominal size of the joined frame, i.e. 16″×20″ or 8″×10″, etc. An industry wide allowance of ⅛″ is typically provided when the four frame legs are mitered, thus changing the size of the two example frame sizes inside the rabbet to 16-⅛″×20⅛″ or 8⅛″×10⅛″. The protective glass or plastic sheet being cut to the nominal size is therefore sufficiently undersized to accept the protrusion (see the protrusion in FIG. 5).

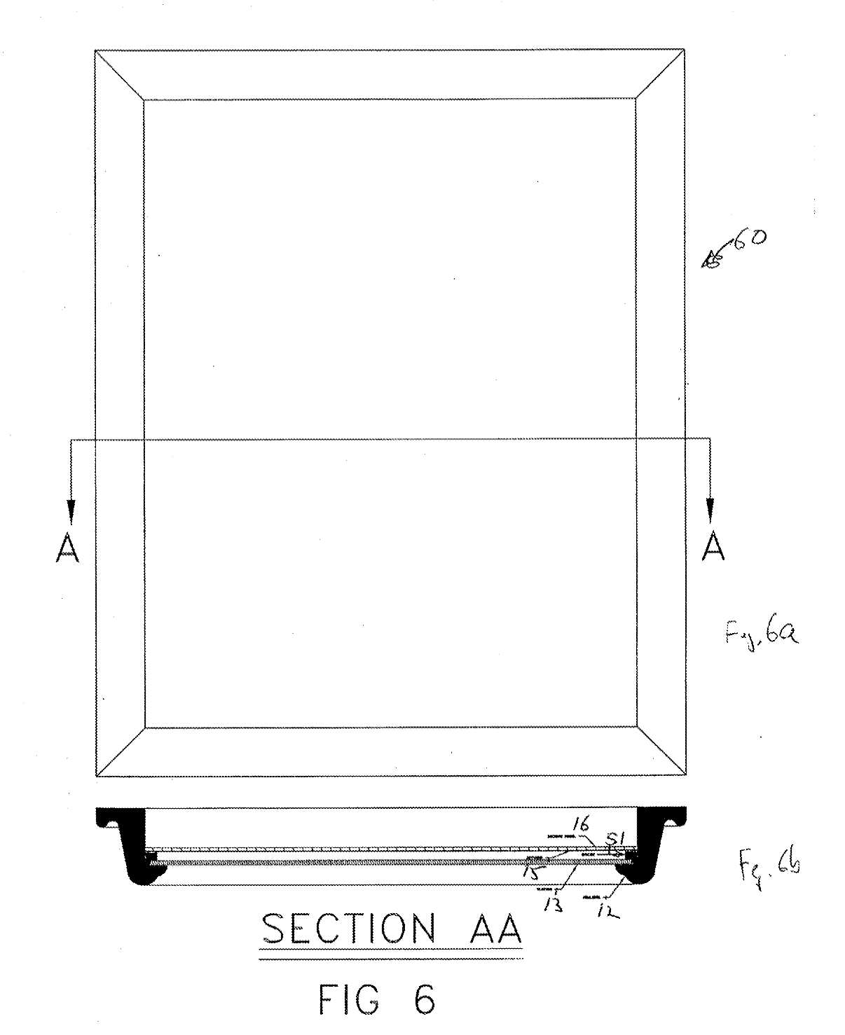

FIG. 6b shows cross section AA of a complete picture frame assembly (FIG. 6a).

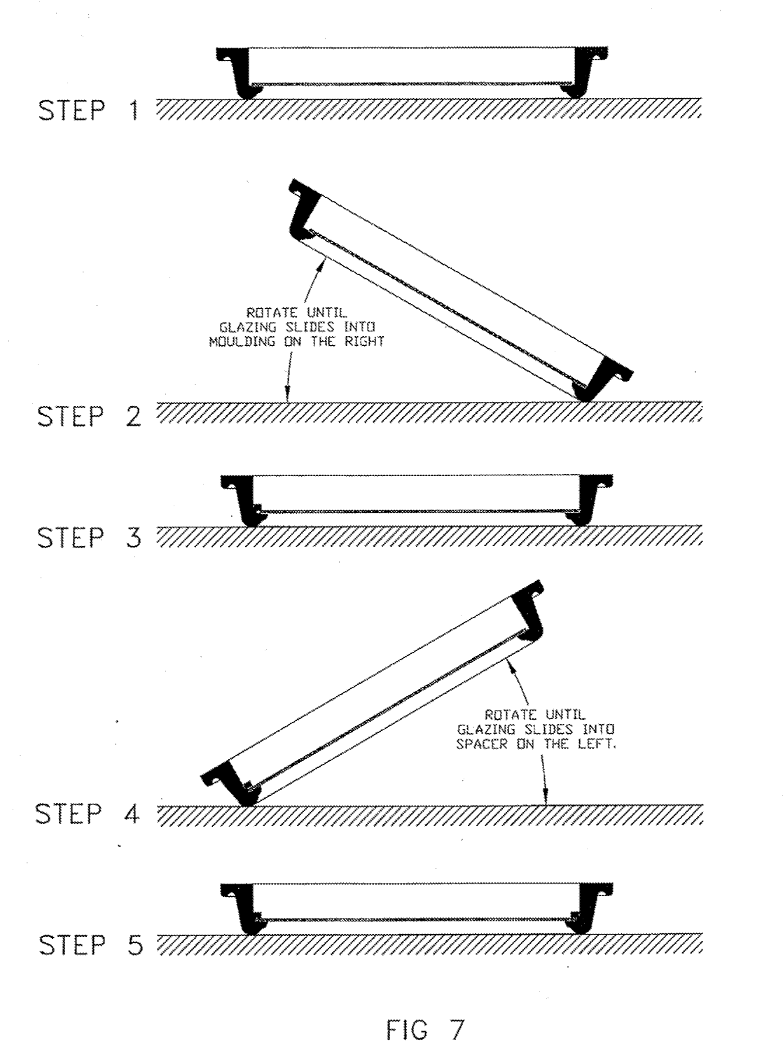

FIG. 7 shows the steps used to install the spacer. An assembled frame of molding is placed face down on the work table and a piece of protective glass or plastic sheet is cut as described above and placed in the opening, as shown in FIG. 7 Step 1. In Step 2, the assembled molding is lifted first by one edge until the glass seats against the opposite side of the molding and then it is laid back down. In Step 3, a spacer of appropriate pre-cut length is laid in the gap created at the lifted edge. In Step 4, the opposite side of the assembled molding is lifted until the protective glass or plastic sheet seats against the spacer, the combination of which seats against the frame. In Step 5, a second spacer is laid in the remaining gap. This process is repeated for the two remaining sides. Thereafter, the artwork, which has been mounted on the backing panel (see FIG. 5) can be dropped into the mounding opening and held into position using the standard methods.

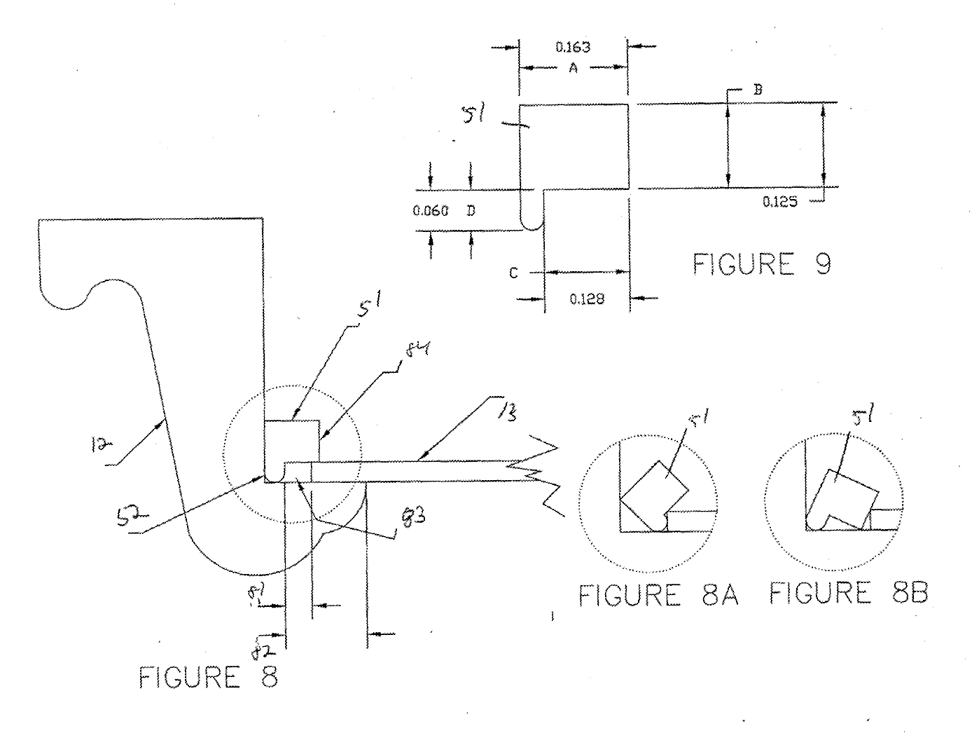

FIG. 8A illustrates why dimension C should be greater than 50% of the thickness of the protective glass or plastic sheet to prevent jamming, as described above. FIG. 5B illustrates that dimension C must always greater than the protrusion-glazing gap lest the leading edge of the spacer fall into the protective glass or plastic sheet gap, thus disallowing the protective glass or plastic sheet to be seated properly against the spacer, Dimension C should be as large as possible to accommodate the broadest range of gap tolerances, while still not extending past the molding rabbet. Multiple thicknesses of spacers are used. The most common values for dimension B would be 1/16, ⅛, ¼, ⅜ or ¾-inch.

FIG. 9 identifies key dimensions of an exemplary embodiment of the inventive spacer. Those skilled in the art will appreciate that other dimensions and dimensional relationships are possible and within the scope of the invention. Generally, dimension D must be less than the thickness of the glazing material. A general guideline is that dimension D should be not less than 50% or more than 110% of the thickness of the protective glass or plastic sheet material. This minimum thickness holds up the spacer so it does not jam between the protective glass or plastic sheet and the molding. Because the most common protective glass or plastic sheet material is single strength glass, having a thickness that is nominally 0.093-inches thick, the preferred dimension range is 0.046 to 0.107-inches. Double strength glass is nominally 0.125 inches thick, and for this maternal the preferred dimension range is 0.063 to 0.137-inches. Other preferred dimensions are required for other thickness of protective glass or plastic sheet glazing and are within the scope of the invention.

Spacers can be made of many materials, but the following materials are preferred because they are generally inert, contain few if any acid radicals, and do not have plasticizers which can outgas and damage artwork. Spacers may be made in range of colors and in, black, white, transparent, and translucent shades, A preferred material of construction is Polymethyl methacrylate (PMMA) commonly known as acrylic. Another preferred material is Polyethylene Terephthalate (PETG). Another preferred material is Polyethylene Terephalate (PET). Other materials can be used as long as they are generally acid free and don't contain plasticizers or other volatiles. It is also preferred that plastics with high resistance to UV damage are used. Flexible plastics such as ethylene vinyl acetate copolymers (EVA) and EVA polypropylene blends can also be used for spacers because they are generally acid free and do not contain plasticizers or other volatiles.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A picture frame spacer, comprising:
an elongate member having a generally rectangular in shape and further comprising a protrusion extending from one side thereof.

2. The picture frame spacer of claim 1, said member having a width, excluding the width of the protrusion that is greater than 50% of the thickness of the protective glass or plastic sheet.

3. The picture frame spacer of claim 1, said member having a width, excluding the width of the protrusion, that is greater than a protrusion-glazing gap to prevent a leading edge of said member from falling into a gap between said picture frame and a protective glass or plastic sheet.

4. The picture frame spacer of claim 1, said member having a width, excluding the width of the protrusion, that is as large as possible to accommodate a broadest range of tolerances for a gap between said picture frame and a protective glass or plastic sheet, while still not extending past a picture frame rabbet.

5. The picture frame spacer of claim 1, said protrusion having a length that is less than the thickness of said protective glass or plastic sheet.

6. The picture frame spacer of claim 1, said protrusion having a length that is not less than 50% nor more than 110% of the thickness of the protective glass or plastic sheet.

7. The picture frame spacer of claim 1, said protrusion having a length from 0.046 to 0.107-inches for single strength glass and having a length from 0.063 to 0.137-inches for double strength glass.

8. The picture frame spacer of claim 1 said member being fabricated from a material that is generally inert, contains few if any acid radicals, and does not have plasticizers which can outgas and damage artwork.

9. The picture frame spacer of claim 1, said member being fabricated from any of Polymethyl methacrylate (PMMA) commonly known as acrylic, Polyethylene Terephthalate (PETI), and Polyethylene Terephalate (PET).

10. The picture frame spacer of claim 1, said member being fabricated from a material that has high resistance to UV damage.

11. The picture frame spacer of claim 1, said member being fabricated from a flexible plastic.

12. The picture frame spacer of claim 11, wherein said flexible plastic comprises any of ethylene vinyl acetate copolymers (EVA) and EVA polypropylene blends.

13. The picture frame spacer of claim 1, wherein said member is hollow.

14. A method for spacing artwork from a transparent covering in a picture frame, comprising the steps of:
placing a picture frame face down on a work surface;
providing a picture frame spacer comprising an elongate member having a generally rectangular in shape and further comprising a protrusion extending from one side thereof;
cutting a protective glass or plastic sheet to a nominal size of said picture frame, wherein said protective glass or plastic sheet is sufficiently undersized to accept said protrusion;
placing said protective glass or plastic sheet in an opening defined by said picture frame;
lifting said picture frame first by one side until said protective glass or plastic sheet seats against an opposite side of said frame and then laying said frame back down;
laying a section of said spacer of appropriate pre-cut length into a gap created at said lifted side;
lifting an opposite side of said frame until the protective glass or plastic sheet seats against said spacer, the combination of which seats against the picture frame;
laying a second section of said spacer into a gap thus formed;
repeating the foregoing lifting and laying steps for the remaining sides of said picture frame;
placing artwork which has been mounted on a backing panel, into said picture frame opening; and
securing said artwork in position in said picture frame.
